(19) United States
(12) Patent Application Publication
(10) Pub. No.: US 2014/0229267 A1
(43) Pub. Date: Aug. 14, 2014

(54) DATA VISUALISATION TOOL

(71) Applicant: EMAILVISION HOLDINGS LIMITED, London (GB)

(72) Inventors: Paul Creamer, London (GB); Charles Wells, London (GB)

(73) Assignee: EMAILVISION HOLDINGS LIMITED, London (GB)

(21) Appl. No.: 13/764,078

(22) Filed: Feb. 11, 2013

(51) Int. Cl. G06Q 30/02

(52) U.S. Cl. CPC G06Q 30/0242
USPC 705/14.41

(57) ABSTRACT

A rapidly configurable data visualisation tool for enabling a user to carry out a desired analysis function to identify trends within stored data sets is described. The tool comprises: a very large database having a plurality of base model database tables, each base model table being configured to store predetermined data variables relating to a previously implemented complex function and having one or more predetermined base analysis fields associated with each table; a configuration module arranged to present to the user a plurality of the predetermined base analysis fields for user selection to configure the desired analysis function on the data sets; and an analysis module for reading out the data stored in the base model tables in the selected base analysis fields in accordance with the desired analysis function and conducting further processing on the data to create a base analysis result comprising other composite selected base analysis fields in accordance with the desired analysis function.

### FIELD OF THE INVENTION

This invention relates to a data visualisation tool, and in particular, but not exclusively, the invention relates to a data visualisation tool which is used as an analytic system which is suitable for analysing marketing campaign data.

### BACKGROUND TO THE INVENTION

In modern marketing, powerful analytic systems are used by marketers in order to extract data from a database that will aid them with their marketing campaigns. There are a whole host of different types of marketing campaigns that they may wish to conduct, some of the most common examples including: up-sell campaigns, in which marketers try to influence customers to purchase a more expensive model or service from a range of products that they are considering; retention campaigns in which marketers target their existing customers and give them incentives to remain loyal to a company; and new-client campaigns, in which marketers try to identify and win new customers. Clearly, these three types of campaign are very different in terms of the people who are being targeted, and the objectives to be achieved. This means that the marketers need to obtain relevant data that specifically relates to their target group of people, or market segment, so that trends in the data can be identified. This will allow for the marketing campaign to be tailored accordingly.

In particular, these types of marketing campaign relate to vertical markets, or simply ‘verticals’, which are groups of similar businesses or customers who operate in a particular niche area.

There is therefore a requirement for an analytic system that is capable of applying user-definable selections to a very large database defined as one containing the equivalent of at least one hundred thousand rows of data, and typically one which has the equivalent of at least 1,000,000 row entries relating to e-mail marketing campaign results information which is updated row by row. The user-definable selections need to be able to return useful statistics that relate only to the group of people that is being targeted by the current campaign. The campaign, which is directed to a large selection of people and which is determined through an intelligent process according to a series of objectives is known as a “complex function”. As the database contains so many rows of data, and as the data is updated regularly, extracting the relevant data accurately and efficiently is a complex and demanding technical task. Furthermore, there may be a large number of variables that contribute to a given selection, and so setting the selection up correctly can be an extremely complex process.

At present, there are known systems which are able to analyse data from a database in the way described above, and which will return results pertaining to a selected subset of the data to a user through a data visualisation tool. The tool will highlight any trends within the subset of data to the user, which they can use for their marketing purposes.

However, there are a plurality of barriers that stand in the way of small companies who may wish to use an analytic system to aid them with their marketing campaigns. The first barrier is the high cost of purchasing the software tool in the first place; ranging from around GBP 100,000 to over GBP 1,000,000, a cost which is prohibitive for many small enterprises. Additionally, once the software tool has been procured, the database needs to be loaded with useful data to analyse, which may not be readily available. A final barrier is the problem outlined above; once a software tool has been purchased, setting it up correctly for the types of campaign that the company wishes to conduct is a highly complex task that can take a considerable amount of time; a basic setup can take around a month, and more complex projects can last over a year. At a typical cost of £1000 per day, this represents a considerable added expense on top of the initial cost of purchasing the software tool.

The first two of these problems have been mitigated in the state-of-the-art by providing the software tool on a “Software as a Service” (SaaS) platform, meaning that the software and its associated database are hosted on a third party server, and the user accesses them over a network, generally the internet. SaaS is therefore a form of “cloud computing”, in which computing resources are accessed and used over a network. The database is pre-populated with data, which may originate from the host's email marketing system, so that the user is not required to find their own data. The user then only needs to pay a licence fee, rather than purchase the software and the hardware required to run it on.

However, in the SaaS arrangements that are currently known in the art, the user is still required to configure the software in the same way as before, which means that the second barrier, namely the high cost of configuring the analytic system, is still an issue. At present, the two options that are open to a company wishing to use these services are to train internal staff to configure the software manually and then allocate time to the task, or alternatively to employ the services of a third-party consultant to manually configure the software tool for them. Both of these options have a considerable cost associated with them and are prone to human error, so therefore are not ideal solutions.

An additional technical problem exists with the current systems in that, because the user has selected a subset of data to perform their analysis on, it is possible that they have missed some relevant data if the parameters for defining the subset are too narrow. Therefore, if a trend exists over two different data sets, this would be missed by the user in their manual configuration of the software tool.

It is desired to overcome or substantially reduce at least some of the above described problems with analytic systems which currently form the state of the art.

### SUMMARY OF THE INVENTION

It is one object of the present invention to provide an improved data visualisation tool for analytic systems for use in marketing, which overcomes or alleviates the aforementioned disadvantages known in the prior art.

According to one aspect of the present invention there is provided a rapidly configurable data visualisation tool for enabling a user to carry out a desired analysis function to identify trends within stored data sets, the tool comprising: a very large database having a plurality of base model database tables, each base model table being configured to store predetermined data variables relating to a previously implemented complex function and having one or more predetermined base analysis fields associated with each table; a configuration module arranged to present to the user a plurality of the predetermined base analysis fields for user selection to configure the desired analysis function on the data sets; and an analysis module for reading out the data stored in the base model tables in the selected base analysis fields in accordance with the desired analysis function and conducting further processing on the data to create a base analysis result comprising other composite selected base analysis fields in accordance with the desired analysis function.

Preferably the other composite analysis fields are predetermined and stored in the analysis module. Also the previously implemented complex function may comprise a messaging marketing campaign, such as an e-mail marketing campaign or an SMS message marketing campaign. Furthermore, the system may further comprise an email system for providing the messaging marketing campaign data variables.

The base model tables may comprise a Campaign table storing parameters relating to the email marketing campaign, a Member table storing parameters relating to the members or customers targeted in the email marketing campaign, a CampaignMember table storing parameters relating to the messages sent to a member or customer in the email marketing campaign, a Response table storing parameters relating to the customer responses to the received email, and/or a Bounce table storing parameters relating non-delivery of emails during the email marketing campaign.

The data visualisation tool may be hosted by a central server and is accessible to a plurality of remote user computers via a wide area communications network.

The database may comprise a set of averaged base model analysis results and the analysis module may be arranged to update the set of averaged base model results and to use the averaged base model results in carrying out the desired data analysis function.

The analysis module may be arranged to carry out statistical analysis using the analysis field data to provide the base analysis result.

The tool may further comprise a plurality of predetermined template data tables stored within the database, each template data table being associated with a specific sector of operation and having one or more predetermined template analysis fields. In this embodiment, the user may have the option to select template analysis fields without selecting any base analysis fields, to define the desired analysis function.

In this case the configuration module can be arranged to enable a remote user to select one of the plurality of predetermined template data tables relating to the desired analysis specific to a selected sector, to upload sector specific data from the remote user in a format determined by the selected template data table and to populate the corresponding template data table with the uploaded sector data.

The configuration module may be arranged to enable the remote user to select one or more of the template analysis fields of the selected template data table to provide the desired analysis.

The analysis module may comprise a template analysis module for reading out the data stored in the selected template analysis fields of the template data tables in accordance with the desired analysis function and conducting further processing on the data to create a template analysis result comprising other composite selected template analysis fields in accordance with the desired analysis function.

The template analysis module can be arranged to receive the base analysis result from the analysis module and use this to create the template analysis result.

The template analysis module may be arranged to create the template analysis result by carrying out statistical analysis on the template analysis fields and the base analysis result.

The template analysis module can be arranged to carry out analysis to identify trends between the sector data and the previously implemented complex function data.

The database may comprise a set of averaged sector template analysis results and the template analysis module may be arranged to use the set of averaged sector template analysis results in determining the template analysis result and to update the set of averaged sector template analysis results.

The analysis module may be arranged to act according to a schedule to read out some of the data stored in the base model tables and conduct further processing on the data to create a partial base analysis result in advance of the user defining a desired analysis function, such that the partial base analysis result is immediately available to the user.

The analysis module may be arranged to act according to a schedule to read out some of the data stored in the template data tables and conduct further processing on the data to create a partial template analysis result in advance of the user defining a desired analysis function, such that the partial template analysis result is immediately available to the user.

Preferably, the configuration module is arranged to enable the remote user to define one or more base analysis fields or other composite defined base analysis fields to provide the desired analysis. Alternatively or in addition, the configuration module may be arranged to enable the remote user to define one or more template analysis fields or other composite defined template analysis fields to provide the desired analysis.

The tool may further comprise a graphical user interface for presenting the base analysis result to a remote user computer. Alternatively or in addition, the tool may comprise a graphical user interface for presenting the template analysis result to a remote user computer.

According to another aspect of the present invention there is provided a method of rapidly configuring a data visualisation tool for enabling a user to carry out a desired analysis function to identify trends within stored data sets, the method comprising: providing a plurality of base model database tables in a very large database, each base model table being configured to store predetermined data variables relating to a previously implemented complex function and having one or more predetermined base analysis fields associated with each table; presenting to the user a plurality of the predetermined base analysis fields for user selection to configure the desired analysis function on the data sets; reading out the data stored in the base model tables in the selected base analysis fields in accordance with the desired analysis function; and conducting further processing on the data to create a base analysis result comprising other composite selected base analysis fields in accordance with the desired analysis function.

The present invention also extends to a computer readable data carrier comprising a computer program for generating instructions for causing a computer to perform a method of rapidly configuring a data visualisation tool for enabling a user to carry out a desired analysis function to identify trends within stored data sets, the method comprising: providing a plurality of base model database tables in a very large database, each base model table being configured to store predetermined data variables relating to a previously implemented complex function and having one or more predetermined base analysis fields associated with each table; presenting to the user a plurality of the predetermined base analysis fields for user selection to configure the desired analysis function on the data sets; reading out the data stored in the base model tables in the selected base analysis fields in accordance with the desired analysis function; and conducting further processing on the data to create a base analysis result comprising other composite selected base analysis fields in accordance with the desired analysis function.

According to another aspect of the present invention there is provided a data visualisation tool for analysing at least one set of data, to identify trends within the set of data, or between two or more sets of data; the tool being hosted by a third party remotely from a user, such that the user may conduct an analysis and view an analysis result remotely; the data visualisation tool comprising: a very large database comprising the set of data; an analysis module arranged to analyse data using a table relating to a particular commercial area of interest; the table comprising a pre-defined set of analysis fields, each analysis field relating to a particular characteristic of a subject to which the data relates and being user selectable to configure an analysis rapidly; wherein the analysis module is arranged to combine the results for two or more user-selected individual analysis fields in order to identify trends within the data set, or between two or more data sets.

### BRIEF DESCRIPTION OF THE DRAWINGS

In order that the invention may be more readily understood, preferred non-limiting embodiments thereof will now be described with reference to the accompanying drawings, in which like features are assigned like reference numerals, and in which:

FIG. 1 is a schematic block diagram showing the overall architecture of the data visualisation tool according to the present embodiment;

FIG. 2 is a schematic block diagram showing the architecture of the analysis module of FIG. 1;

FIG. 3 is a schematic block diagram showing the architecture of the base model analysis module of FIG. 2 and the base model database tables of FIG. 1;

FIG. 4 is a schematic block diagram showing the architecture of the template analysis module of FIG. 2 and the associated template data tables of FIG. 1;

FIG. 5 is a flow diagram showing a process for visualising data relating to a particular vertical market using the data visualisation tool in FIG. 1;

FIG. 6 is a flow diagram showing a subroutine of the process of FIG. 5 for the configuration stage of the process;

FIG. 7 is a flow diagram showing a sub routine of the process of FIG. 5 for the base model analysis stage of the process;

FIG. 8 is a flow diagram showing a subroutine of the process of FIG. 5 for the sector-specific template analysis stage of the process;

FIG. 9 is a schematic drawing showing the components of the base model analysis module and the template analysis module of FIG. 2 involved in the analysis of a first example analysis, for the e-commerce sector;

FIG. 10 is a schematic drawing showing the components of the base model analysis module and the template analysis module of FIG. 2 involved in the analysis of a second example analysis, for the online gambling sector;

FIG. 11 is a Venn diagram showing an example of a data analysis result which may be performed by the data visualisation tool in FIG. 1;

FIG. 12 is a screenshot of the user interface in FIG. 1, showing the results of a data analysis performed by a user for emails which lead to purchases in the e-commerce sector;

FIG. 13 is a close-up view of a part of the user interface in FIG. 1, showing a tree-style menu of options available to a user;

FIG. 14 is a screenshot of the user interface in FIG. 1, showing the results of a data analysis performed by a user on data which they have supplied;

FIG. 15 is a table containing a list of examples of analysis fields which are included with the base model database tables and template model database tables of FIG. 1;

FIG. 16 is a table containing a list of typical marketing objectives that a user may use the data visualisation tool of FIG. 1 to attempt to satisfy;

FIG. 17 is a table containing examples of pre-configured sample analysis options which the user can select in the user interface of FIGS. 12 to 14 in order to compare two or more analysis fields in a pre-determined way;

FIG. 18 is a table showing the structure of a template database table which is to be populated with user-supplied data relating to purchase data for the e-commerce sector; and

FIG. 19 is a table showing the structure of a template database table which is to be populated with user-supplied data relating to product data for the e-commerce sector.

### DETAILED DESCRIPTION OF EMBODIMENTS OF THE INVENTION

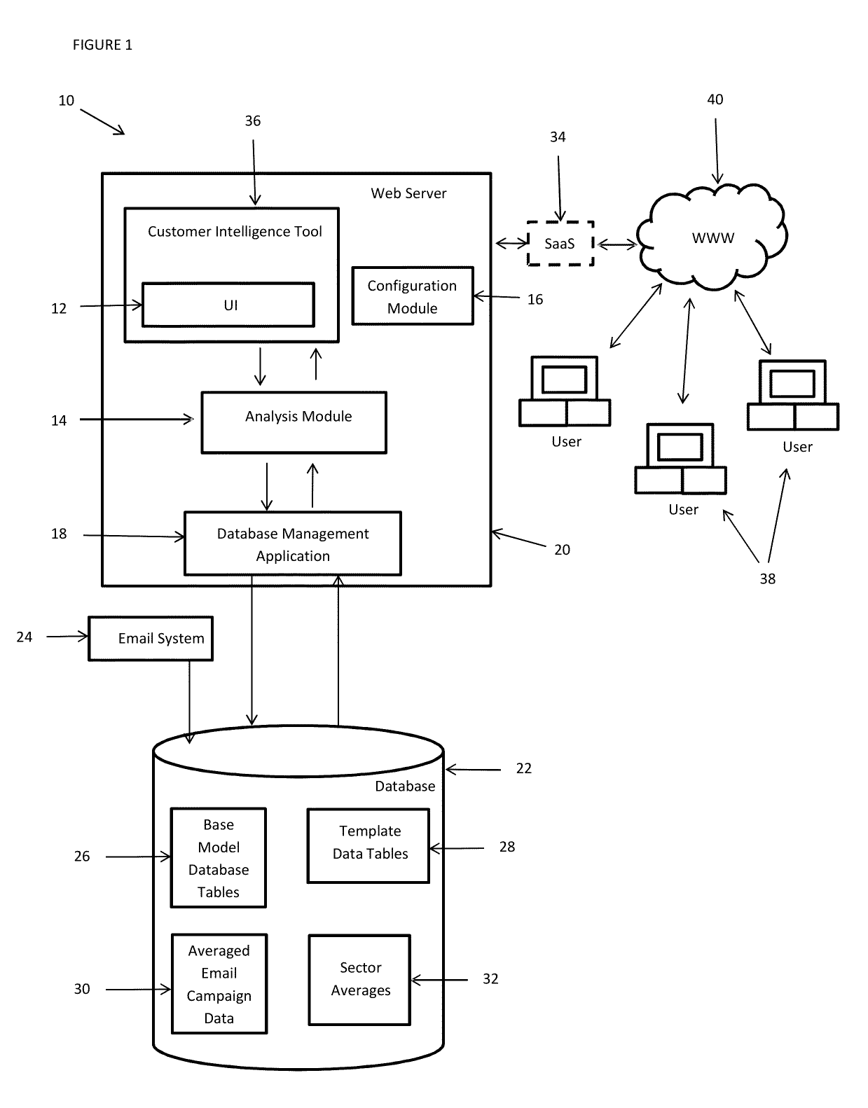

With reference to FIG. 1, an embodiment of a data visualisation tool 10 according to the invention comprises a user interface (UI) 12, an analysis module 14, a configuration module 16, and a database management application 18, all of which are hosted on a web server 20. The data visualisation tool 10 further comprises a database 22 and an email system 24 which may itself be hosted on an email server (not shown). The components which are hosted on the web server 20 communicate with the database 22, which in turn is supplied with data by the email system 24. The database 22 is provided with several components which facilitate arrangement of data into a format which is compatible with the analysis module 14. These components include base model database tables 26, template data tables 28, averaged email campaign data 30 and sector averages 32.

The data visualisation tool 10 is arranged to be accessed remotely by a user, in that it is provided as a “Software as a Service” (SaaS) 34. To this end, the UI 12 is provided on a web page, which in this embodiment is known as a Customer Intelligence Tool 36. By providing the data visualisation tool 10 as a SaaS 34, analysis results may be sent to multiple remote user computers 38 who are connected to a communications network, for example, the World Wide Web (WWW) 40.

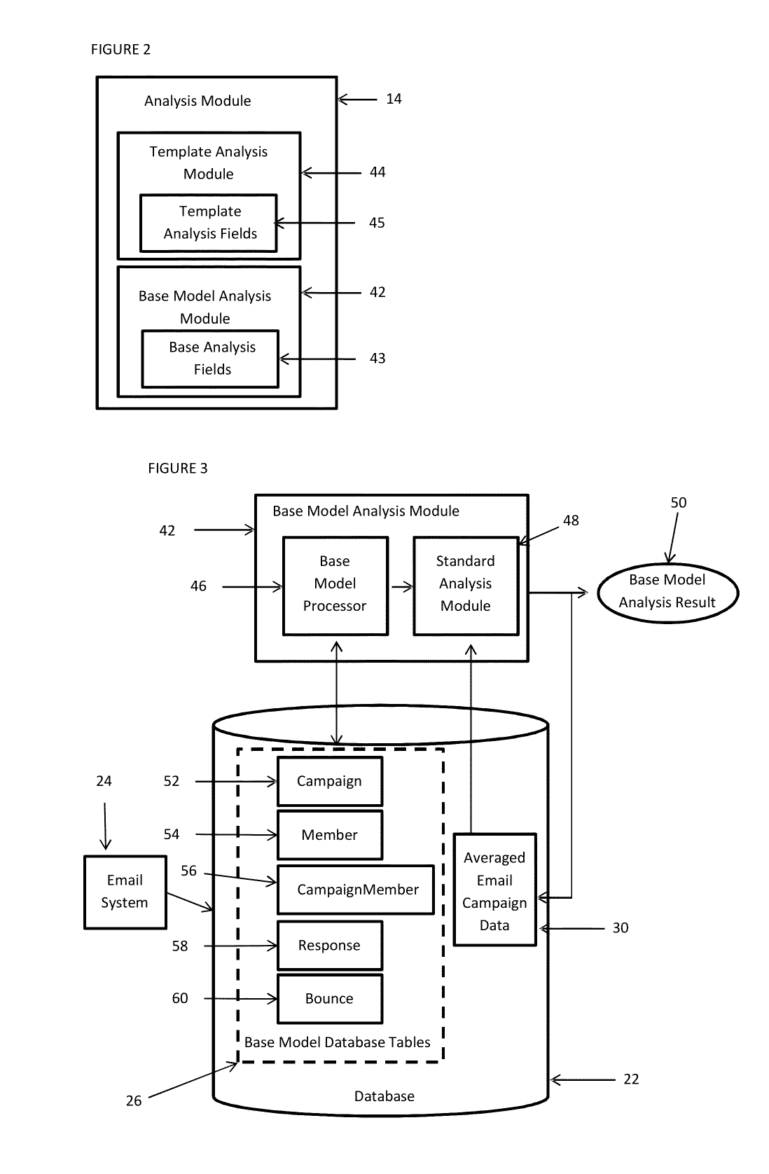

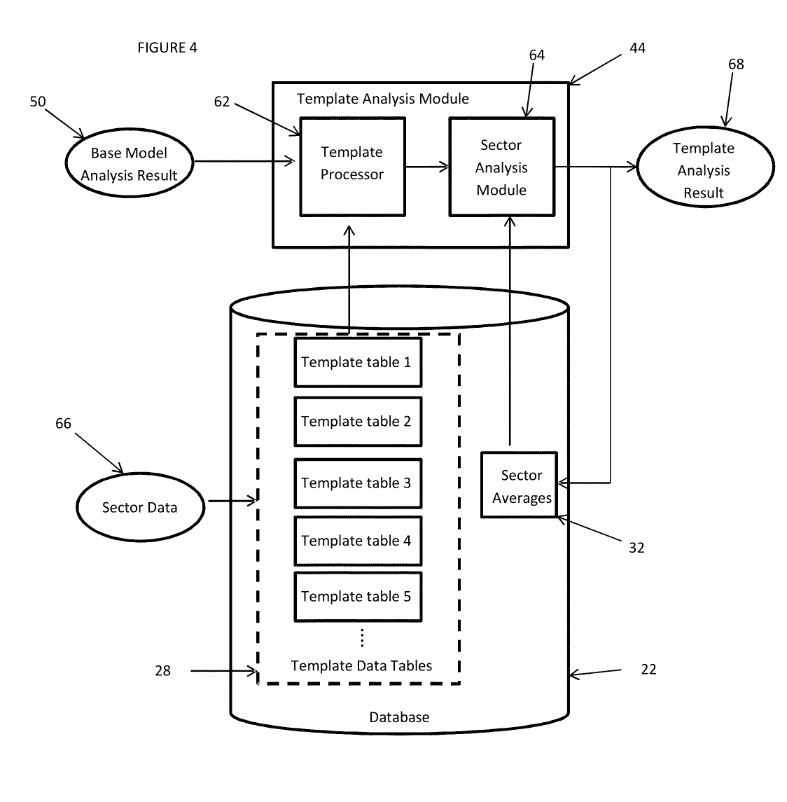

The data visualisation tool 10 is arranged to provide two levels of analysis for a user: base model analysis, and template analysis. For this reason, the analysis module 14 comprises two corresponding analysis components, a base model analysis module 42 and a template analysis module 44, as shown in FIG. 2. These components are described in more detail later with reference to FIGS. 3 and 4.

The base model analysis module 42 relates to email campaign data from the email system 24, and is generally, although not always, used as the first step in any analysis which is conducted by the data visualisation tool 10. In this embodiment, the email campaign data is supplied to the user as part of the data visualisation tool 10, although in other embodiments the user may supplement this data with data from their own campaigns, which may, for example, include data relating to email marketing, SMS messaging marketing, or standard mail marketing. The base model analysis module 42 may alternatively relate to data obtained from SMS message campaigns, or a combination of both email and SMS message related data, all of which is provided by the email system 24. The data which is contained in the email system 24 is updated daily, so as to reflect the latest information. Averaged email campaign data 30 results from previous base model analyses are used to enrich the current analysis by providing an indication of certain performance metrics for the user. The base model analysis module 42 is provided with a plurality of base analysis fields 43 which are used to analyse the data contained in the database 22.

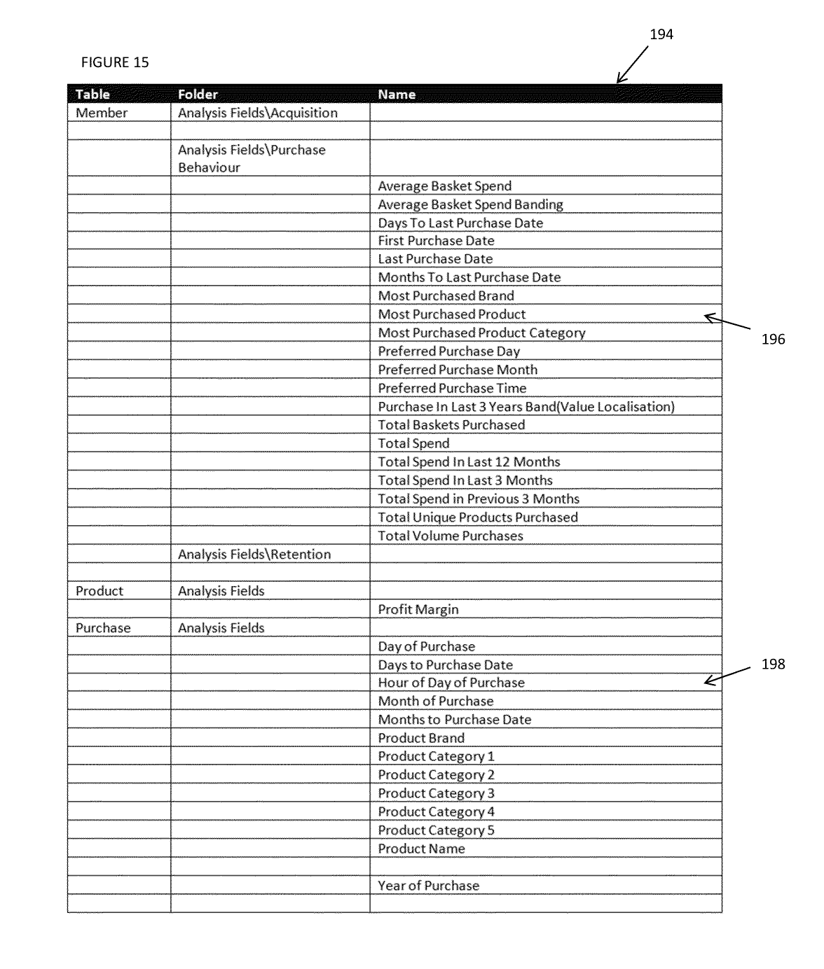

An analysis field is a low-level characteristic (or metric) of the subject being analysed, which may be represented by a simple statistic, or a more complex metric based on a plurality of such lower-level characteristics or combinations of such lower-level characteristics. For example, if the subject is a member of an email campaign, this might have associated analysis fields including the average spend for that member, or the days since that member's last purchase. A more detailed list of example analysis fields is described later with reference to FIGS. 12 and 15. Different analysis fields may be combined in order to provide additional insight; using the examples given above, an example combination might be to identify members who have made a purchase in the last month, and who spend at least £100 per visit. This analysis would identify members who are active and who spend more than average, and are therefore good candidates for a new marketing campaign for higher value products. Clearly, if more analysis fields are provided, the user is able to combine the fields in many more different ways in order to tailor their analysis to find out exactly what they need to. In this way, the analysis fields cooperate to create a powerful analysis tool which will satisfy most of the requirements that a marketer has.

The base analysis fields 43 are pre-configured for the user, and are optimised to provide the user access to the types of analysis which they are most likely to require. The user has the option to add additional base analysis fields 43 to the base model analysis module 42 in order to further tailor the data visualisation tool 10 more closely to their requirements.

For some users, the base model analysis satisfies all of their needs; however, many users need to combine this analysis with other types of data which relate specifically to their industry vertical. For these users, the second level of analysis is provided on top of the base model analysis: the template analysis, which is conducted using the template analysis module 44. For this, the user is required to provide the relevant data for the additional analysis. The user is supplied with instructions which specify the format which the data needs to be provided in, such that it can be used to populate the template data tables 28. Analysis results from the base model analysis module 42 can then be sent to the template analysis module 44 to be combined with the user supplied data to provide analysis results which are tailored to the user's requirements. As with the base model analysis, averaged template data results from previous template analysis are used to enrich the current analysis, by providing an indication of additional performance metrics. The template module is also provided with a plurality of template analysis fields 45, which operate in a similar manner to the base analysis fields 43 included with the base model analysis module 42. Again, the template analysis fields 45 included with the template analysis module 44 are preconfigured for the user, and are optimised to provide useful analytic capabilities for the particular segment to which the template relates “out of the box”. As with the base model analysis module 42, the user is able to add additional analysis fields 45 to the template analysis module 44. A template data table 28 of a predetermined structure (format) is provided for each industry vertical (sector). This means that the user inputs data into the system in a constrained manner using the selected template data table 28 which enables the system to offer predetermined template analysis fields 45 which are useful for that sector.

The configuration module 16 is used to set up the data visualisation tool 10 for the specific type of analysis that the user wishes to conduct. This process includes establishing the correct template data tables 28 to be used, and organising the UI 12 appropriately to give the user the correct options for analysis. In this embodiment, the configuration process is completed prior to the user conducting any analysis; however in an alternative embodiment the user can re-configure the data visualisation tool 10 periodically according to their needs.

The configuration process is both short, and simple enough to be carried out by a user. This accords this embodiment a clear benefit with regard to the known analytic systems discussed earlier.

In use, when an analysis is initiated by a user, the user first uses the UI 12 to select the analysis fields 43, 45 which are required for the analysis. Then, if the analysis includes base analysis fields 43, email related data is pulled out of the email system 24 and used to populate the base model database tables 26. In another embodiment, email related data is pulled out of the email system 24 according to a schedule, for example on a daily basis, and used to populate the base model database tables 26. In this alternative embodiment, the base model database tables 26 are already populated when the user comes to perform an analysis, which reduces the time taken to perform the analysis. Furthermore, both the base model analysis module 42 and the template analysis module 44 may be arranged to perform some analytical tasks according to a similar schedule, in order to make some analysis results immediately available to the user.

Returning to the present embodiment, once the base model database tables have been populated, the email related data is then extracted from the database 22 by the database management application 18, and passed on to the analysis module 14. The analysis module 14 then analyses the data using the base analysis fields 43 that have been selected by the user. In addition to this, if a user has supplied data which is specific to their industry, for example purchasing data for an e-commerce analysis via the template data tables 28, this is also extracted and passed on to the analysis module 14 in the same way as the base model data, and is analysed against the relevant template analysis fields 45.

It is noted that the user may initiate an analysis containing either base analysis fields 43, template analysis fields 45, or a combination of the two. The analysis module 14 performs an analysis which is appropriate to the selected analysis fields 43, 45; for example, if only template analysis fields 45 are selected, the analysis module 14 will not involve the base analysis module 42 in the analysis. Furthermore, in some instances, the analysis fields 43, 45 selected by the user may require that template analysis is conducted prior to base model analysis.

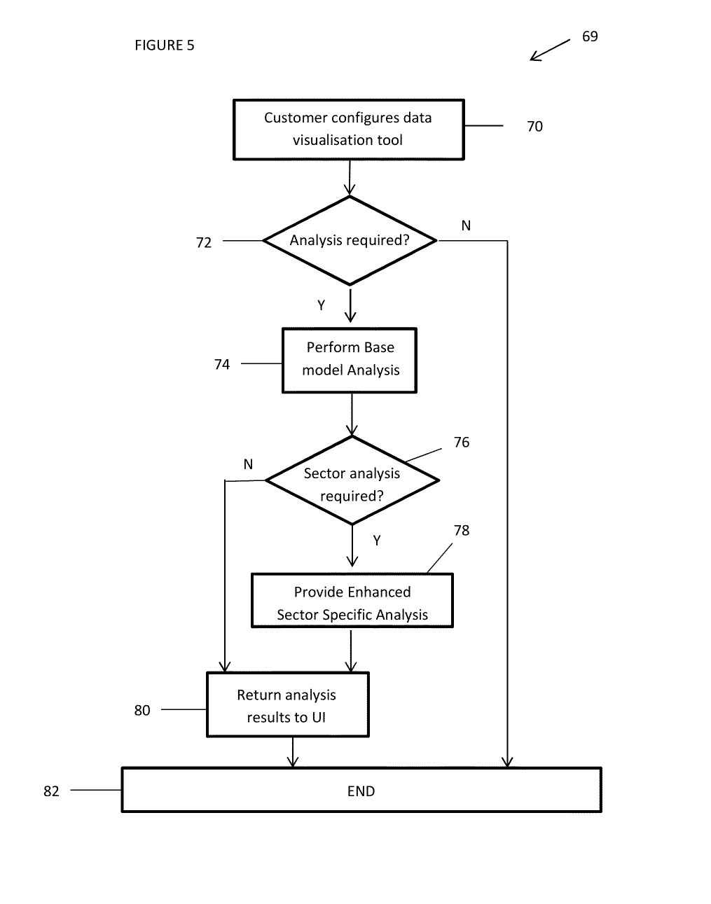

Once the analysis is complete, the results are returned to the database 22 via the database management application 18 to update both the averaged email campaign data 30, and, if appropriate, the sector averages 32. The results are then passed on to the UI 12, which is arranged to receive the analysis results and to process them into a useful format for presenting to a user computer 38. The process that the data visualisation tool 10 undertakes when performing an analysis is described in further detail later, with reference to FIGS. 5 to 8. Once the results have been presented to the user computer 38, they can use the information to gain new insight into their market industry vertical. In addition to this, they can export the data to an external program, such as Microsoft Excel®, for further processing. A further option for the user is to use the analysis result to derive a target list of customers for a new email campaign.

Referring now to FIG. 3, the base model analysis module 42 comprises a base model processor 46 and a standard analysis module 48. These components interact with the database 22 and the email system 24 to perform a base model analysis. The base model processor 46 is used to pull data from the email system 24 to populate much of the base model database tables 26 such that the data is in the correct form for analysis, and then to read the data from the base model database tables 26 to be analysed by the standard analysis module 48.

Sorting the data into the base model database tables 26 in itself provides a level of analysis, in that this process identifies the raw data which is relevant to a user. This is then built on by the standard analysis module 48, which enriches the data using basic statistical functions to fill in the base analysis fields to produce a base model analysis result 50 For example, if the base model processor 46 has extracted raw data relating to the dates on which each email was opened by the customer to whom it was sent, there may be a base analysis field 43 to indicate the most popular day of the week on which emails are opened. The standard analysis module 48 can readily calculate a result for this base analysis field 43 from the raw data which has been made available by the base model processor 46, by analysing the set of dates provided. The standard analysis module 48 also uses the averaged email campaign data 30 from previous analyses to further enrich the present analysis. Once the data has been analysed, the base model analysis result 50 is then fed back to the database 22 to be added to the store of averaged email campaign data 30. Finally, the base model analysis result 50 is either sent on to the UI 12, for presenting to the user computer 38, or, if template analysis is required, the base model analysis result 50 is sent as semi-processed data to the template analysis module 44.

In this embodiment, the base model database tables 26 include five different tables, which are labelled as “campaign” 52, “member” 54, “campaignmember” 56, “response” 58, and “bounce” 60. The tables are populated as follows:

The “campaign” 52 table is populated with information about the email and mobile campaigns sent by the user, for instance the date on which the emails or SMS messages were sent, and the number of emails/SMS messages included in the campaign.

The “member” table 54 is populated with information relating to the user's customers, i.e. specifically which email addresses or mobile telephone numbers the emails and/or SMS messages were sent to.

The “campaignmember” table 56 is used to contain data concerning the actual emails and/or SMS messages which were sent to customers as part of a campaign, i.e. the actual text of an email, and any links or advertisements that were included.

The “response” table 58 is populated with data concerning each customer's response to a specific email (and/or SMS message), for example whether they read the email, or whether they clicked on a link contained in the email.

The “bounce” table 60 is used to record emails and/or SMS messages which were sent out as part of a campaign, but were not successfully delivered.

Due to the way in which these base model database tables 52, 54, 56, 58, 60 are configured, some basic information relating to the email campaign is revealed through the sorting process. For example, a list of customers who received and read a particular email which was sent out can be easily generated. In addition to this, each table has several associated base analysis fields 43. For example, the “member” table 54 could contain data which corresponds to base analysis fields 43 such as “date of birth”, “sex” and “location”. These analysis fields 43 can be used to target particular groups of customers in the analysis, for example.

From this point, the standard analysis module 48 performs a basic analysis to provide some more detailed information for the user which begins to identify trends in the data. As outlined above, the user could select to look at which day of the week customers were most responsive to emails from a particular campaign by selecting the relevant base analysis fields 43 in the UI 12. Once the basic analysis is completed, this can be compared with the average results for other email campaigns, to see how the current campaign compares with past campaigns. The analysis process is carried out such that the resulting averaged results of several analyses provide an indication for several performance metrics which may be of interest to the user.

Referring now to FIG. 4, the template analysis module 44 takes a similar form to the base model analysis module 42, in that it comprises a template processor 62 and a sector analysis module 64, which interact with other components of the system to perform the template analysis. The template processor 62 receives a base model analysis result 50 from the base model analysis module 42, which is to be used in the template analysis. The template data tables 28 are pre-populated with sector data 66, which is the data that is supplied by the user. The template processor 62 reads in the sector data 66 from the template data tables 28. The nature of the template data tables 28 will be particular to the specific type of template which is being provided, and so the template data tables 28 are not described in detail at this stage. In general, the template data tables 28 take a similar form to the base model database tables 26, and are arranged such that the template processor 62 only needs to read data in from the correct table 28 in order to obtain the required information; no additional analysis is applied directly to the sector data 66. Additionally, each template data table 28 has several associated template analysis fields 45, similar to the base model database tables 26.

Once the base model analysis result 50 and the relevant sector data 66 have been obtained by the template processor 62, this data is all forwarded to the sector analysis module 64, which is arranged to perform analysis to reveal trends between the two types of data. These trends may relate to performance metrics which will be of interest to the user. The sector analysis module 64 outputs a template analysis result 68. As an example, if the template relates to e-commerce, a typical template analysis result 68 which the sector analysis module 64 may return is to show the number of customers who received an email from a campaign, clicked through a link contained in the email, and then purchased the item to which the email campaign related. This result could be compared with the number of customers who, having received the email, did not go on to make a purchase, to provide an indication of how effective the email campaign had been. Each of these types of results relate to specific analysis fields 43, 45 provided in the base model analysis module 42 and the template analysis module 44, which have been selected by the user, and analysis fields contained within the base model database tables 26 and template data tables 28. Thus useful analysis across both email campaigns and e-commerce data sets is obtained.

To take this example further, the user could then select further specific analysis fields 43, 45, which relate to a different sector and thus be based on a different template data table 28, to improve their understanding of how the email campaign has been effective. This could include looking at what proportion of the customers who purchased a product are male, or fall into a certain age bracket. This information may help the user to improve the next email campaign such that it will be effective in influencing customers who were not motivated to make a purchase by the previous campaign.

Other examples of the types of industry vertical for which a template may be provided include: on-line gambling; interactions, for users whose customers interact with them via forums or competitions for example; publishing, for users that run subscription-based new media (content which is available on demand, often digitally) operations; travel; and organisation sales, relating to “business-to-business” (B2B) sales. The types of template data tables 28 which may be used by the template analysis module 44 will be tailored for each of these types of template. Additionally, there may be many different types of table 28 used in each template; there is no technical limitation on how many different types of table 28 may be used, although often there is a practical limitation of two or three different tables 28, as it may be impractical and time consuming for a customer to fit their data to more tables 28 than this. Furthermore, the template data tables 28 which are provided to the user initially should be treated as a starting point. The user can define new template data tables 28 and new analysis fields 45 to further tailor the analysis to their requirements.

As with the base model analysis module 42, the template analysis module 44 is arranged to maintain a set of averaged data for all template analysis results 68. The averaged data provides an indication for several different performance metrics that are of interest to the user. These averages are stored as the sector averages 32, and can be used to indicate to the user how typical the results of a current analysis are. When a new template analysis result 68 is generated by the template analysis module 44, it is added to the sector averages 32. The template analysis result 68 is then forwarded to the UI 12, to be formatted and sent to the user computer 38 for presentation to the user.

FIGS. 5 to 8 show the process that the data visualisation tool 10 undergoes when the user initiates a new analysis.

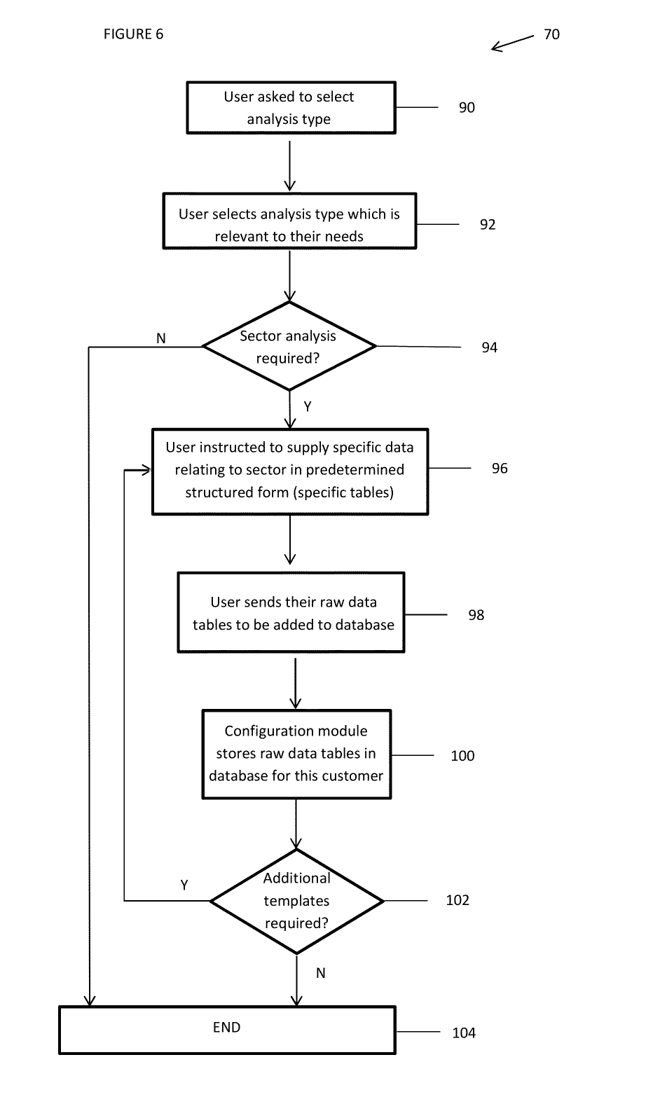

In FIG. 5, an overview of the analysis process 69 is illustrated. First, the user configures at Step 70 the data visualisation tool 10 for the type of analysis which is required. This process is described in further detail with reference to FIG. 6. The user then instructs at Step 72 the tool whether analysis is required at that point. If analysis is not required, the process ends at Step 82. If analysis is required, the analysis process 69 is initiated in the analysis module 14, and the base model analysis module 42 performs at Step 74 base model analysis on the data. The analysis process 69 continues with the analysis module 14 then checking at Step 76 whether template analysis is required on top of the base model analysis 74. If not, the results 50 from the base model analysis module 42 are returned at Step 80 to the UI 12 to be formatted and presented to the user via the user computer 38. The process then ends at Step 82. If template analysis is required, this is provided at Step 78. The results 68 from the template analysis are returned at Step 80 to the UI 12 to be formatted and presented to the user, after which the process ends at Step 82.

With reference now to FIG. 6, a sub-process for configuring the data visualisation tool 10 in Step 70 using the configuration module 16 is shown. This is an example of an arrangement in which the user configures the tool themselves; in other arrangements, the data visualisation tool 10 is provided to the user in a pre-configured state. When configuring the tool, the user is asked at Step 90 to select the analysis type which is appropriate to their needs. The user then selects at Step 92 the relevant analysis type. At this stage, the configuration module 16 determines at Step 94 whether sector (template) analysis is required. If the user selected at Step 92 base model analysis only, sector analysis is not required, so the configuration process 70 ends at Step 104. If any other type of analysis is required, the user is instructed at Step 96 to supply the relevant sector data 66 which will be used in the analysis. The data is supplied in a pre-determined form, to fit to the form of the template data tables 28. The user then sends at Step 98 the raw sector data 66, and the configuration module 16 then stores at Step 100 the data in the template data tables 28 in the database 22. The configuration module then checks at Step 102 whether the user requires additional templates. If a further template is required, the process returns to Step 96 and repeats the process for adding sector data. Otherwise, the configuration process 70 then ends at Step 104.

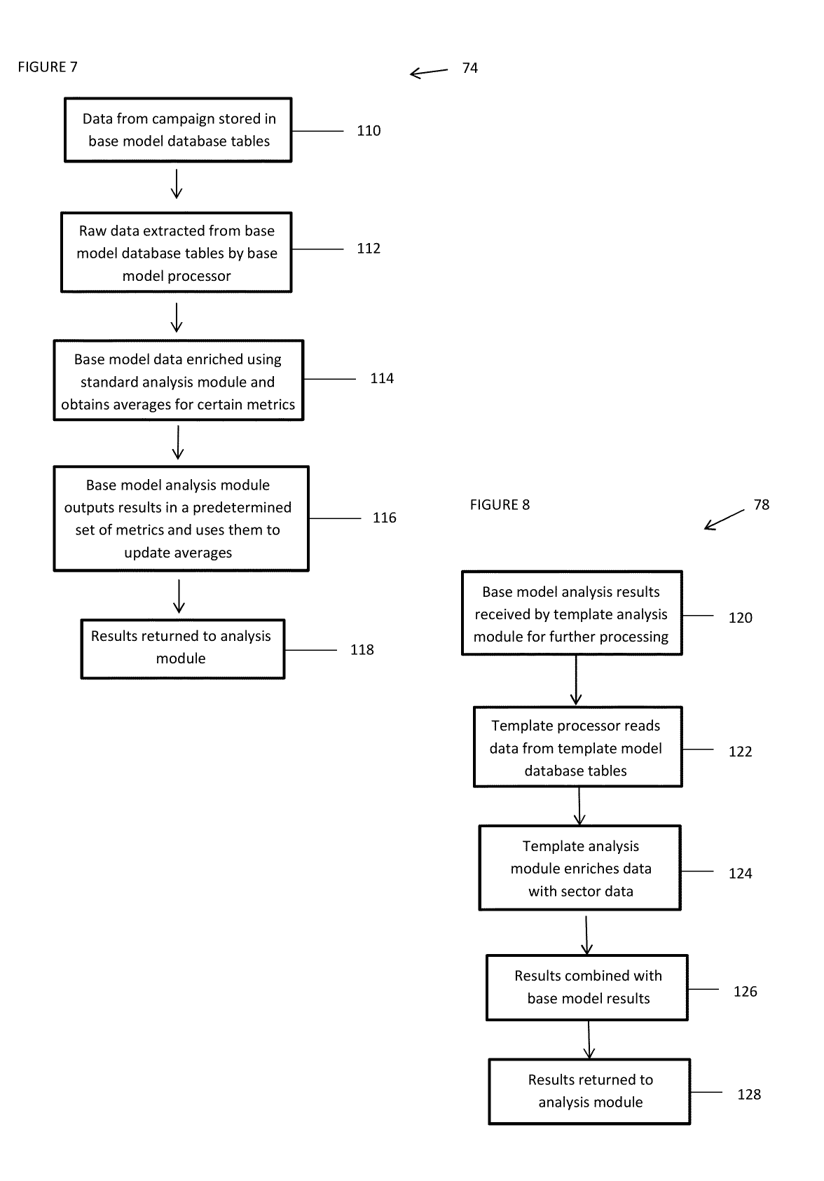

FIG. 7 illustrates the sub-process for the base model analysis which is performed at Step 74 of FIG. 5 in more detail. First, raw data is read out from the email system 24, sorted and stored at Step 110 in the base model database tables 26 by the base model processor 46. Then, the data is extracted at Step 112 from the base model database tables 26 by the base model processor 46. The data is then passed on to the standard analysis module 48 which enriches at Step 114 the data by performing basic statistical analysis to identify trends relating to certain performance metrics for the user. The standard analysis module 48 outputs at Step 116 a base model analysis result 50 in a predetermined set of metrics, and uses that result 50 to update a set of averages. The base model analysis result 50 is then returned at Step 118 to the analysis module 14, which completes the sub-process and moves on to Step 76 of the analysis process 69 shown in FIG. 5.

In FIG. 8, a sub-process for the enhanced sector specific (template) analysis which is performed at Step 78 of FIG. 5 is shown. The process 78 begins when the template analysis module 44 receives at Step 120 the base model analysis result 50 which was obtained in Step 76. Next, the template processor 62 reads at Step 122 the sector data 66 out from the template data tables 28. The template analysis module 44 then enriches at Step 124 the sector data 66 using the sector analysis module 64 to compare the current sector data 66 with the sector averages 32. Once this is complete, the sector analysis module 64 then combines at Step 126 the enriched sector data 66 with the base model analysis result 50 to produce the template analysis result 68. The template analysis result 68 is then returned at Step 128 to the analysis module 14, which completes the sub-process and moves on to Step 80 of the analysis process 69 shown in FIG. 5.

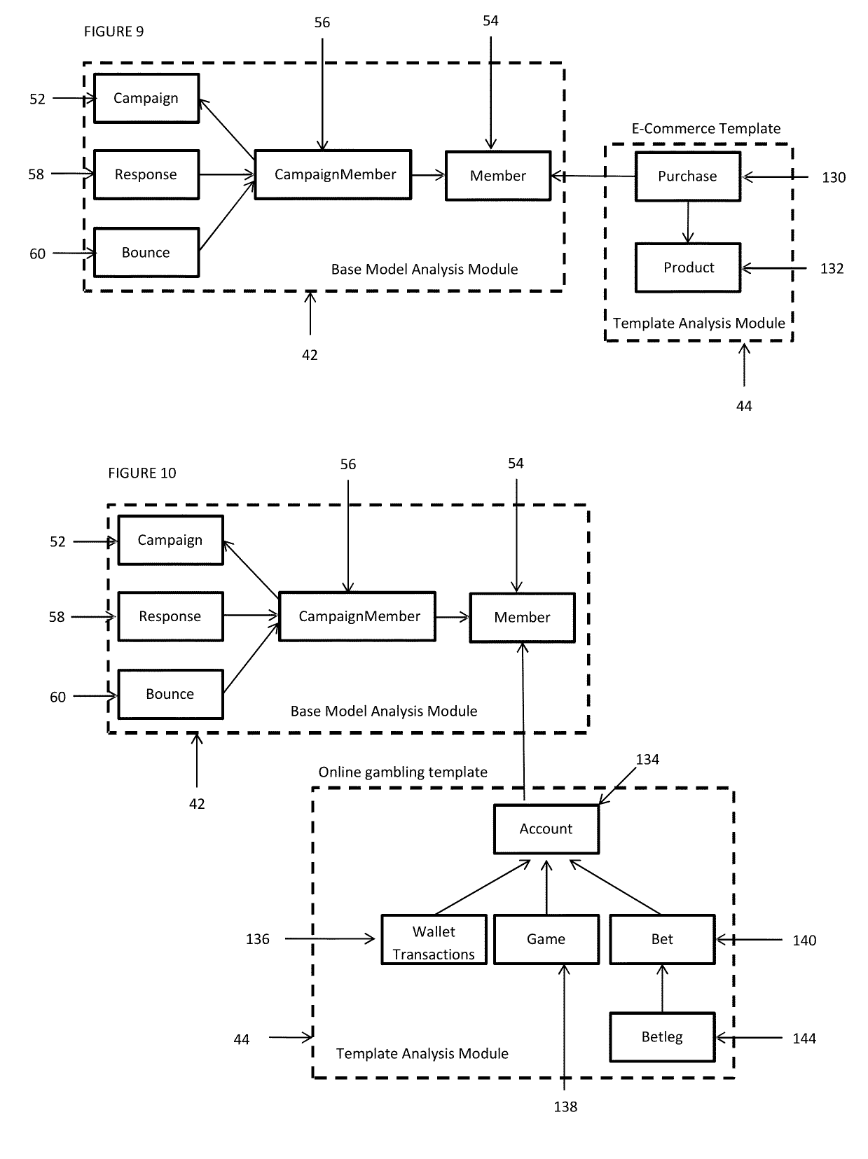

In order to further aid understanding of the invention for the skilled person, two worked examples of an analysis are now described with reference to FIGS. 9 and 10.

FIG. 9 illustrates the interactions between the different data tables 26, 28 involved in an analysis for the e-commerce sector. As shown, the analysis starts with the base model analysis module 42, and then moves on to the template analysis module 44 in the manner described previously with reference to the earlier figures. FIG. 9 provides additional insight into the process in that it illustrates the interactions between the different data types within each analysis module, and the order in which data is used. The direction of the arrows in the figure indicates the relationship between different data types; the arrows point towards a parent data type. For example, a member may have emails or SMS messages from multiple campaigns sent to them, therefore the arrow between the “campaignmember” table 56 and the “member” table 54 points towards the “member” table 54.

In FIG. 9 then, the “member” table 54 is the top-level table in the base model, as all arrows point towards it either directly or indirectly. This indicates that the “member” table 54 contains the most fundamental data concerning the marketing campaigns to which the data relates; namely, the customers who were targeted by the campaign. From there additional data, such as the specifics of the messages that were sent, or the way in which customers responded, are added on top.

Once these steps have been completed, the analysis moves on to the template analysis module 44, which in this example contains two types of template data table 28 which are specific to the requirements of a user working in the e-commerce sector: “purchase” 130, and “product” 132. The “product” template data table 132 is populated with details of products which the user wishes to monitor. This data, when combined with the base model analysis result 50, can be used to create a performance metric relating to purchases of those products as a direct result of an email or SMS message campaign, as indicated by the arrows in the figure.

Further detail can be extracted from the data by looking more closely at each template category. For example, a more detailed purchasing analysis may include statistics relating to the frequency of purchases, how recently the purchases have been made, and the value of those purchases. For the product analysis, statistics relating to a breakdown of products by brand or category can be generated, to see which types of product are most successfully sold through an email campaign. Additionally, a pricing and profit analysis can be conducted to reveal the profit or revenue which has been generated by a campaign. All of these different types of analysis can then be presented to the user through the UI 12 using a familiar format such as a Venn diagram, a cross tabulation or a map.

In this way, the data visualisation tool 10 offers the user a level of analysis which is comparable with other analytic systems which are known in the art, but without the associated burden and cost of configuring a bespoke system.

In FIG. 10, another example of an analysis is shown, this time relating to online gambling. The stages for the base model analysis module 42 are identical to those in FIG. 9, and so shall not be described again here. Indeed, the base model analysis will always be the same no matter what type of analysis a user wishes to conduct.

As shown in the figure, the online gambling template contains five different template data tables 28: “account” 134, which relates to the customer accounts which the user wishes to analyse; “wallet transactions” 136, which relates to occasions when a customer has spent money through their account; “game” 138, which relates to occasions when a customer played an online game; “bet” 140, which relates to instances when a customer placed an online bet; and “betleg” 144, which relates to bets which depend on multiple outcomes, for example accumulator bets.

As with the example in FIG. 9, the data which is read out from these template data tables 28 is built up in a logical sequence. Therefore, details of the accounts of all customers are read from the tables first, which can then be referenced against, for example, instances when an account was used to play a game. This information can then be used to assess whether an email campaign had successfully influenced customers to play an online game. Using this template, statistics can be generated which provide an indication of many different performance metrics, for example, customers who play regularly, customers who only play one type of game, customers who have recently set up an account, or customers who spend a larger than average amount of money through their account. This list is by no means exhaustive; clearly there are many different ways in which the data can be used.

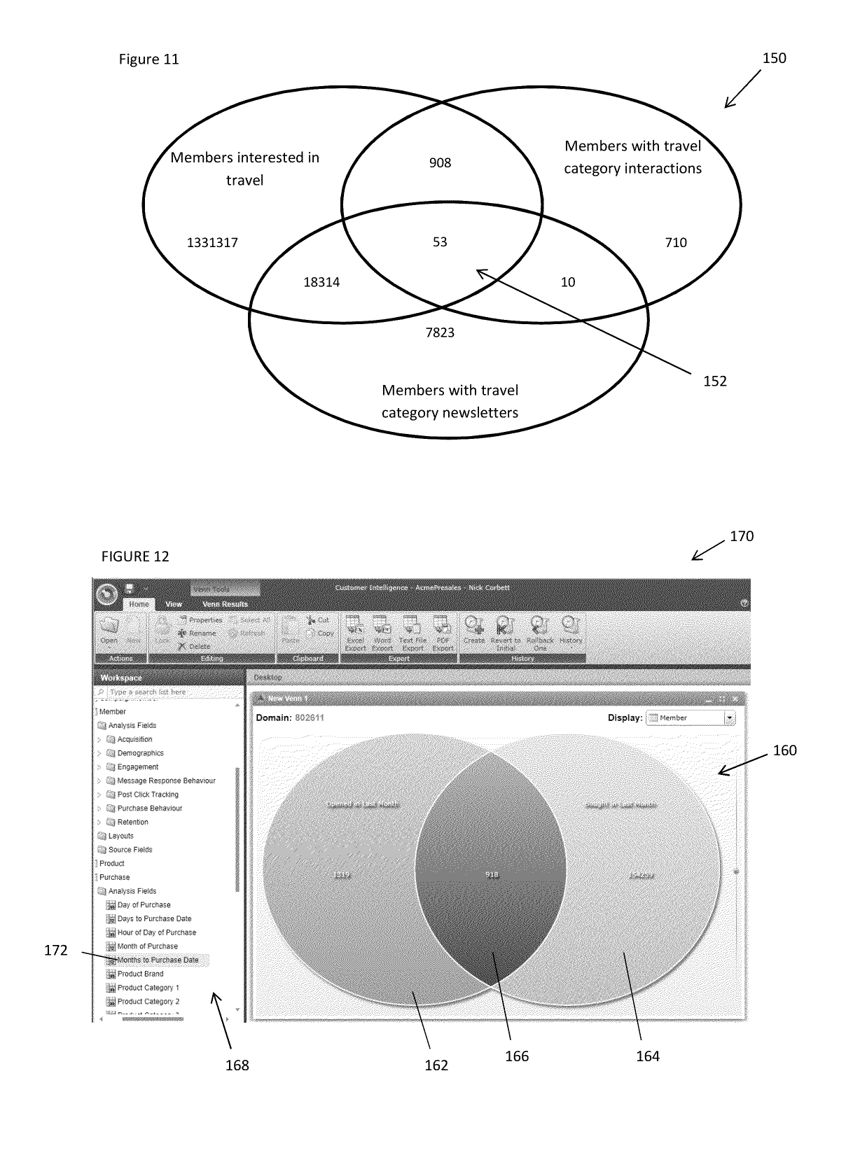

In FIG. 11, the result 68 of a typical analysis relating to a travel sector template is shown. The figure shows a Venn diagram 150 which is representative of what the user would see displayed on their user computer 38 when conducting the analysis through the UI 12. In this example, three different categories of customer, relating to three analysis fields, have been analysed to see how many customers fall into two or more categories. The analysis fields are defined as follows:

“Members interested in travel” simply relates to customers who have expressed an interest in travel;
“Members with travel category interactions” refers to customers who have discussed travel through some form of social media; and
“Members with travel category newsletters” relates to customers who receive travel newsletters.

The segment 152 in the middle of the Venn diagram 150 indicates that there are 53 customers who fall into all three of those categories. These customers are therefore likely to be highly interested in travel, and are therefore prime targets for campaigns relating to travel offers, for example.

FIGS. 12 to 14 are screenshots of the UI 12, which are provided to illustrate how the user interacts with the data visualisation tool 10 in order to generate an analysis result 50, 68. In this arrangement, the UI 12 is provided in a Customer Intelligence Tool 36 (a website). The UI 12 provides a “drag-and-drop” style interface, enabling a user to use the system with little or no training required.

In FIG. 12 a Venn diagram 160 is shown which is the result 68 of an analysis for the e-commerce sector. The analysis compares a base model analysis result 50, 162 (emails opened in the last month) with purchasing data 164 related to the email campaign. The area of overlap 166 indicates the number of customers who, having opened an email sent to them as part of a campaign, went on to purchase the product which was advertised in the email.

The way in which this Venn diagram 160 is obtained by the user is by selecting two different analysis fields from a tree 168 which is shown on the left of the screen 170. FIG. 12 shows the analysis field of “Months to Purchase Date” 164 highlighted; the user has previously selected a “Months to Read Date” analysis field 172. Each of these analysis fields contains multiple values, for example the “Months to Purchase Date” is provided with values such as “last month”, “2 months ago”, “3 months ago”, etc. Similarly the “Months to Read Date” field is provided with the same values. The user has selected the required values, in this example “last month” for both analysis fields, and the data visualisation tool 10 has combined the two to provide the analysis result 68 shown.

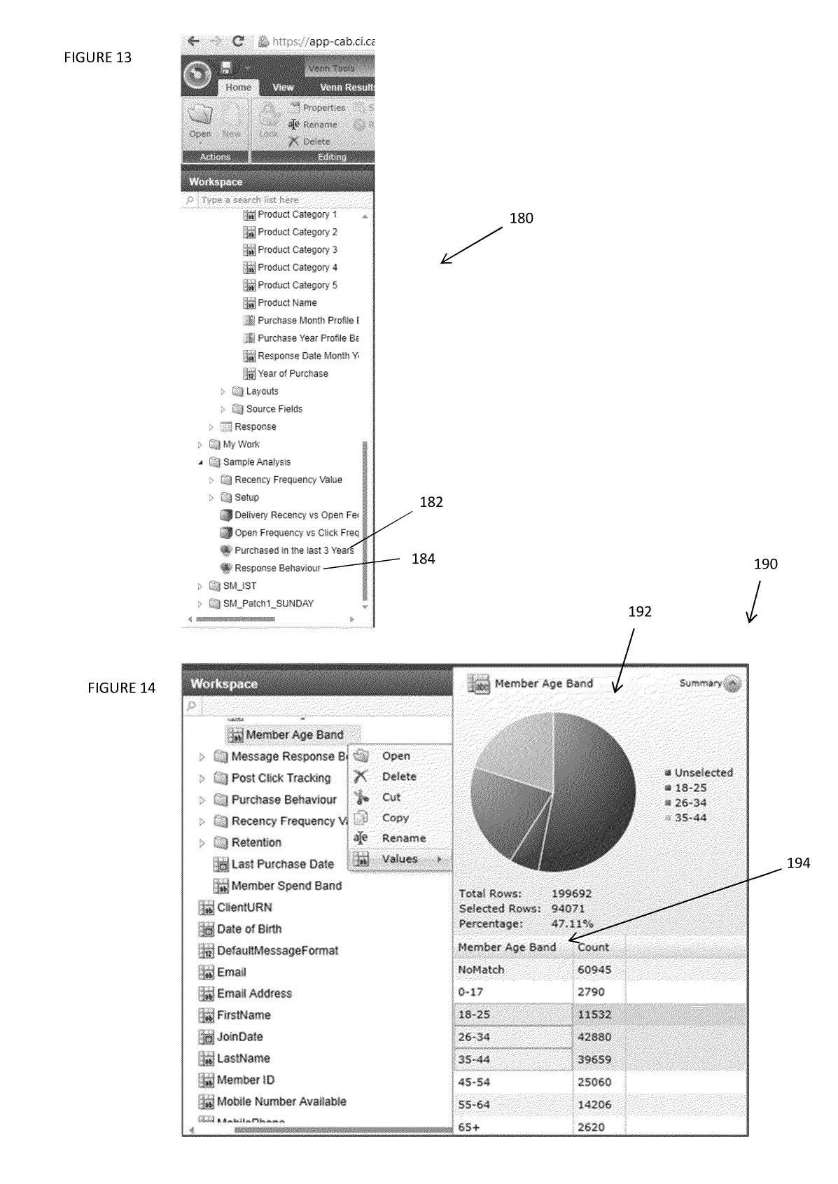

As an alternative to requiring the user to manually select the analysis fields that they wish to analyse, the data visualisation tool 10 can be provided with preconfigured options for analysis, containing two or more analysis fields to be compared in a pre-determined manner, as illustrated in FIG. 13. The tree 180 shown in the figure has two pre-populated Venn diagrams in it (Purchased in the last 3 years 182 and Response Behaviour 184). The user only needs to click on the required option, and the analysis result 68 is presented to them.

In FIG. 14, an example of a simple analysis which uses only the base model analysis module 42 is provided. The example illustrates the implementation of analysis fields in an analysis, in this case, customer age. In the screenshot 190, the user has selected to view a pie chart representation 192 of the age-bands 194 into which members of all campaigns contained in the database fall. One of the pieces of information that is provided by the email system 24 for the base model analysis module 42 is the date of birth of each customer or member included in an email campaign. Using this information, it is a trivial matter for the system to calculate the current ages of those members and present this information to the user in the manner illustrated.

FIGS. 15 to 19 are tables which contain specific examples of the data and analysis fields which are used by the data visualisation tool 10.

FIG. 15 shows a table 194 containing a more extensive, although by no means exhaustive, list of examples of the analysis fields which are included with the analysis module 14. In the top portion of the table 196, example analysis fields relating to “member” 54 are listed, which form part of the base model analysis module 42. Below that in the lower portion of the table 198, there are examples of analysis fields for the “purchase” and “product” tables 130, 132, which form part of the template analysis module 44. It should be noted that the “purchase” 130 section of the table includes some user-definable analysis fields, although the user may define analysis fields for any part of the analysis module 14.

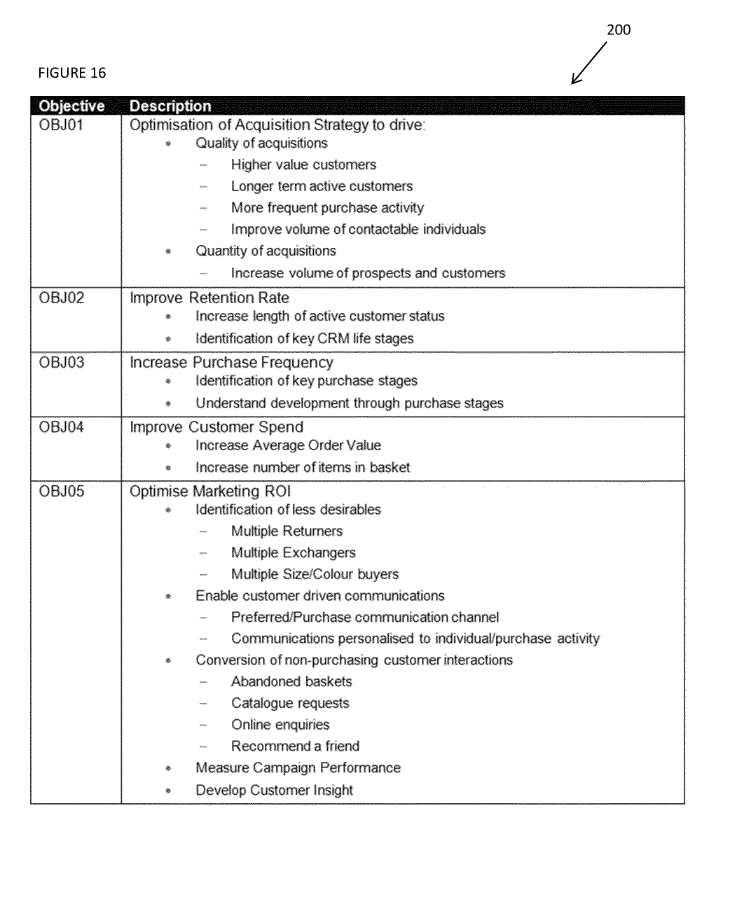

FIG. 16 is a table 200 which contains an example of a list of objectives which a marketer may attempt to achieve through the use of the data visualisation tool 10. These objectives may specify target values of analysis fields to be obtained in order to achieve the objectives.

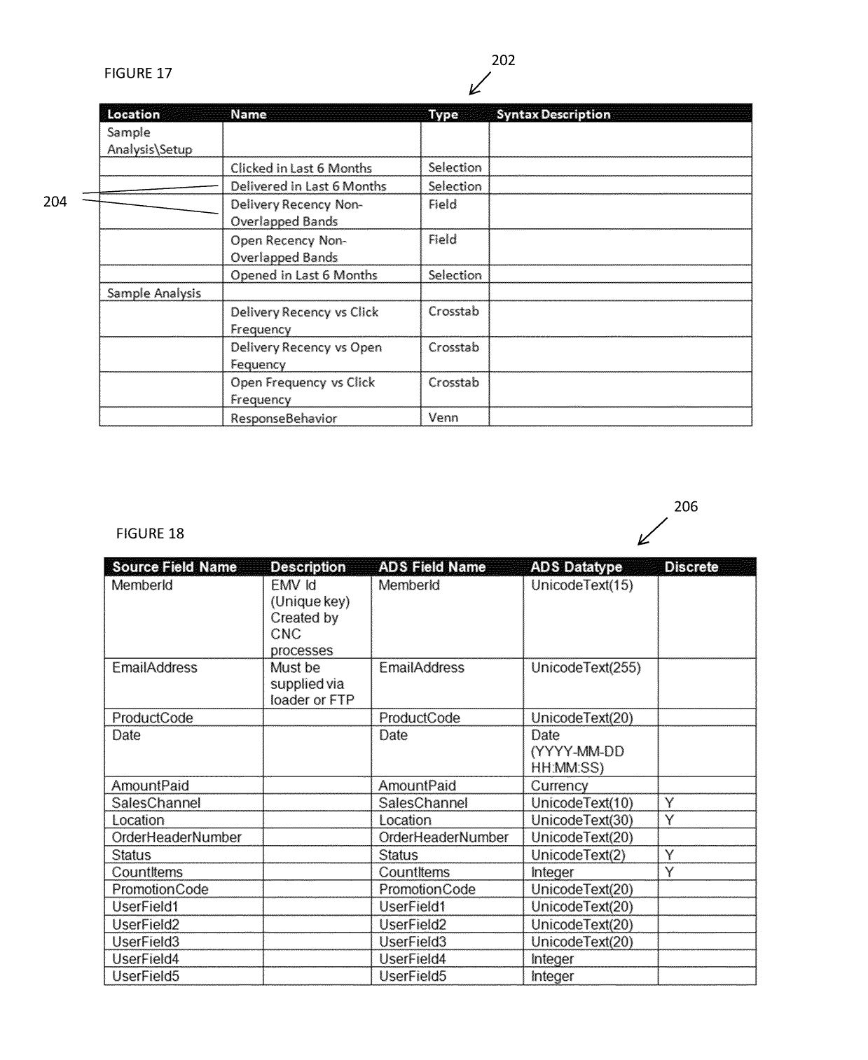

FIG. 17 is a table 202 showing some further examples of pre-defined sample analysis 204 containing a number of commonly-used analysis fields which may be provided to the user in the UI 12. The table 202 provides details of some items which are delivered as a part of the base model analysis module 42. The “location” column indicates where the items are located in the tree 180 of FIG. 13. The “name” column indicates the name of the item. The “type” column indicates the class of analysis which is applied by the item, i.e. how the item is implemented. The “syntax” column, which is not populated in the diagram, indicates the syntax used to create the item.

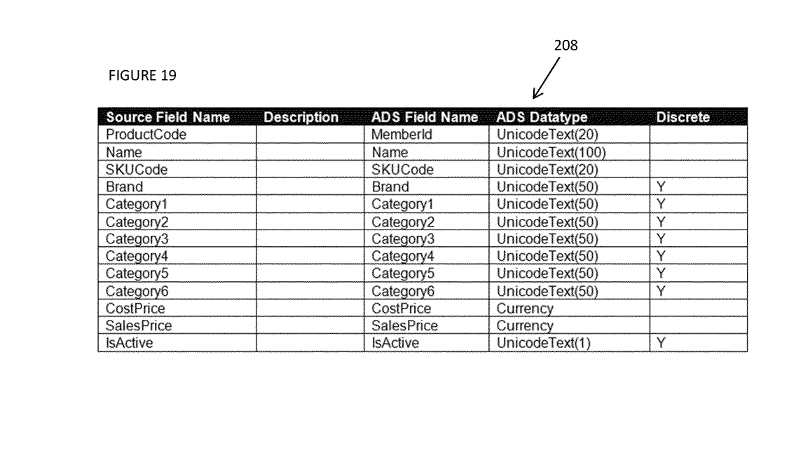

FIGS. 18 and 19 provide two further tables 206, 208 which illustrate an example of a structure in which a user may supply data relating to their sector, to be used in the template analysis module 44. FIG. 18 relates to purchasing data for the e-commerce sector, and FIG. 19 relates to product data, also for the e-commerce sector.

It will be appreciated by a person skilled in the art that the invention could be modified to take many alternative forms to that described herein, without departing from the spirit and scope of the invention as set out in the appended claims. For example, the large database could be made up of a plurality of databases which work together, which may even be remote from each other.

1. A rapidly configurable data visualisation tool for enabling a user to carry out a desired analysis function to identify trends within stored data sets, the tool comprising:
a very large database having a plurality of base model database tables, each base model table being configured to store predetermined data variables relating to a previously implemented complex function and having one or more predetermined base analysis fields associated with each table;
a configuration module arranged to present to the user a plurality of the predetermined base analysis fields for user selection to configure the desired analysis function on the data sets; and
an analysis module for reading out the data stored in the base model tables in the selected base analysis fields in accordance with the desired analysis function and conducting further processing on the data to create a base analysis result comprising other composite selected base analysis fields in accordance with the desired analysis function.

2. The tool according to claim 1, wherein the other composite analysis fields are predetermined and stored in the analysis module.

3. The tool according to claim 1, wherein the previously implemented complex function comprises a messaging marketing campaign.

4. The tool according to claim 3, further comprising an email system for providing the messaging marketing campaign data variables.

5. The tool according to claim 3, wherein the base model tables comprise a Campaign table storing parameters relating to the email marketing campaign.

6. The tool according to claim 3, wherein the base model tables comprise a Member table storing parameters relating to the members or customers targeted in the email marketing campaign.

7. The tool according to claim 3, wherein the base model tables comprise a CampaignMember table storing parameters relating to the messages sent to a member or customer in the email marketing campaign.

8. The tool according to claim 3, wherein the base model tables comprise a Response table storing parameters relating to the customer responses to the received email.

9. The tool according to claim 3, wherein the base model tables comprise a Bounce table storing parameters relating non-delivery of emails during the email marketing campaign.

10. The tool according to claim 1, wherein the data visualisation tool is hosted by a central server and is accessible to a plurality of remote user computers via a wide area communications network.

11. The tool according to claim 1, wherein the database comprises a set of averaged base model analysis results and the analysis module is arranged to update the set of averaged base model results and to use the averaged base model results in carrying out the desired data analysis function.

12. The tool according to claim 1, wherein the analysis module is arranged to carry out statistical analysis using the analysis field data to provide the base analysis result.

13. The tool according to claim 1, further comprising a plurality of predetermined template data tables stored within the database, each template data table being associated with a specific sector of operation and having one or more predetermined template analysis fields.

14. The tool according to claim 13, wherein the configuration module is arranged to enable a remote user to select one of the plurality of predetermined template data tables relating to the desired analysis specific to a selected sector, to upload sector specific data from the remote user in a format determined by the selected template data table and to populate the corresponding template data table with the uploaded sector data.

15. The tool according to claim 14, wherein the configuration module is arranged to enable the remote user to select one or more of the template analysis fields of the selected template data table to provide the desired analysis.

16. The tool according to claim 13, wherein the analysis module comprises a template analysis module for reading out the data stored in the selected template analysis fields of the template data tables in accordance with the desired analysis function and conducting further processing on the data to create a template analysis result comprising other composite selected template analysis fields in accordance with the desired analysis function.

17. The tool according to claim 16, wherein the template analysis module is arranged to receive the base analysis result from the analysis module and use this to create the template analysis result.

18. The tool according to claim 17, wherein the template analysis module is arranged to create the template analysis result by carrying out statistical analysis on the template analysis fields and the base analysis result.

19. The tool according to claim 18, wherein the template analysis module is arranged to carry out analysis to identify trends between the sector data and the previously implemented complex function data.

20. The tool according to claim 16, wherein the database comprises a set of averaged sector template analysis results and the template analysis module is arranged to use the set of averaged sector template analysis results in determining the template analysis result and to update the set of averaged sector template analysis results.

21. The tool according to claim 1, wherein the analysis module is arranged to act according to a schedule to read out some of the data stored in the base model tables and conduct further processing on the data to create a partial base analysis result in advance of the user defining a desired analysis function, such that the partial base analysis result is immediately available to the user.

22. The tool according to claim 13, wherein the analysis module is arranged to act according to a schedule to read out some of the data stored in the template data tables and conduct further processing on the data to create a partial template analysis result in advance of the user defining a desired analysis function, such that the partial template analysis result is immediately available to the user.

23. The tool according to claim 1, wherein the configuration module is arranged to enable the remote user to define one or more base analysis fields or other composite defined base analysis fields to provide the desired analysis.

24. The tool according to claim 15, wherein the configuration module is arranged to enable the remote user to define one or more template analysis fields or other composite defined template analysis fields to provide the desired analysis.

25. The tool according to claim 1, further comprising a graphical user interface for presenting the base analysis result to a remote user computer.

26. The tool according to claim 16, further comprising a graphical user interface for presenting the template analysis result to a remote user computer.

27. A method of rapidly configuring a data visualisation tool for enabling a user to carry out a desired analysis function to identify trends within stored data sets, the method comprising:
providing a plurality of base model database tables in a very large database, each base model table being configured to store predetermined data variables relating to a previously implemented complex function and having one or more predetermined base analysis fields associated with each table;
presenting to the user a plurality of the predetermined base analysis fields for user selection to configure the desired analysis function on the data sets;
reading out the data stored in the base model tables in the selected base analysis fields in accordance with the desired analysis function; and
conducting further processing on the data to create a base analysis result comprising other composite selected base analysis fields in accordance with the desired analysis function.

28. A computer readable data carrier comprising a computer program for generating instructions for causing a computer to perform a method of rapidly configuring a data visualisation tool for enabling a user to carry out a desired analysis function to identify trends within stored data sets, the method comprising:
providing a plurality of base model database tables in a very large database, each base model table being configured to store predetermined data variables relating to a previously implemented complex function and having one or more predetermined base analysis fields associated with each table;
presenting to the user a plurality of the predetermined base analysis fields for user selection to configure the desired analysis function on the data sets;
reading out the data stored in the base model tables in the selected base analysis fields in accordance with the desired analysis function; and
conducting further processing on the data to create a base analysis result comprising other composite selected base analysis fields in accordance with the desired analysis function.

29. A data visualisation tool for analysing at least one set of data, to identify trends within the set of data, or between two or more sets of data; the tool being hosted by a third party remotely from a user, such that the user may conduct an analysis and view an analysis result remotely; the data visualisation tool comprising:
a very large database comprising the set of data;
an analysis module arranged to analyse data using a table relating to a particular commercial area of interest; the table comprising a pre-defined set of analysis fields, each analysis field relating to a particular characteristic of a subject to which the data relates and being user selectable to configure an analysis rapidly;
wherein the analysis module is arranged to combine the results for two or more user-selected individual analysis fields in order to identify trends within the data set, or between two or more data sets.
